(19) United States
(12) Patent Application Publication
(10) Pub. No.: US 2013/0285603 A1
(43) Pub. Date: Oct. 31, 2013

(54) UNIVERSAL WIRELESS CHARGING SYSTEM FOR MOTOR VEHICLES

(71) Applicants: Mark L. Zeinstra, Holland, MI (US); Sam J. Galioto, Holland, MI (US); Gunnar J. Bracelly, Holland, MI (US); Wolfgang Ziegler, Karlsbad (GE); Jens Ohler, Kieselbronn (GE); Benjamin Algera, Holland, MI (US); Jeffrey N. Golden, Holland, MI (US); Thomas Wright, Holland, MI (US)

(72) Inventors: Mark L. Zeinstra, Holland, MI (US); Sam J. Galioto, Holland, MI (US); Gunnar J. Bracelly, Holland, MI (US); Wolfgang Ziegler, Karlsbad (GE); Jens Ohler, Kieselbronn (GE); Benjamin Algera, Holland, MI (US); Jeffrey N. Golden, Holland, MI (US); Thomas Wright, Holland, MI (US)

(73) Assignee: Johnson Controls Technology Company, Holland, MI (US)

(21) Appl. No.: 13/813,405

(22) PCT Filed: Aug. 4, 2011
(86) PCT No.: PCT/US11/46604

§ 371 Date: Jul. 8, 2013

Related U.S. Application Data
(60) Provisional application No. 61/370,710, filed on Aug. 4, 2010.

(51) Int. Cl. H02J 7/02

(52) U.S. Cl. CPC H02J 7/025
USPC 320/108

(57) ABSTRACT

A wireless charging system includes a primary inductive coil configured to transfer electromagnetic energy to a secondary inductive coil of a portable electronic device. The wireless charging system also includes a coil driver electrically coupled to the primary inductive coil and configured to adjust an output signal of the primary inductive coil. The wireless charging system further includes a receiver configured to receive an input signal from the portable electronic device, and a controller communicatively coupled to the receiver and to the coil driver. The controller is configured to establish a wireless charging protocol based on the input signal, and to automatically regulate the output signal based on the established wireless charging protocol and the input signal.

### CROSS REFERENCE TO RELATED APPLICATION

This application claims priority from and the benefit of U.S. Provisional Application Ser. No. 61/370,710, entitled “UNIVERSAL WIRELESS CHARGING SYSTEM FOR MOTOR VEHICLES”, filed Aug. 4, 2010, which is hereby incorporated by reference in its entirety.

### BACKGROUND

The invention relates generally to wireless charging systems for motor vehicles, and more specifically, to a universal wireless charging system configured to automatically adapt to a variety of wireless charging protocols.

Passengers frequently carry portable electronic devices, such as phones, cameras, and music players, into a vehicle. Consequently, it may be desirable for the passengers to charge the portable electronic devices via the vehicle electrical system. As will be appreciated, the portable electronic devices may be connected to the electrical system by a direct wired connection (e.g., a power cable connected to an auxiliary power outlet) or a wireless charging system. Wireless charging systems typically include a primary inductive coil configured to transfer electromagnetic energy from the vehicle electrical system to a secondary inductive coil within the portable electronic device. Unfortunately, a wide variety of wireless charging protocols have been created to facilitate power transfer to the portable electronic devices. As a result, a passenger may be required to provide a different wireless charging system for each electronic device carried into the vehicle.

### BRIEF DESCRIPTION OF THE INVENTION

The present invention relates to a wireless charging system including a primary inductive coil configured to transfer electromagnetic energy to a secondary inductive coil of a portable electronic device. The wireless charging system also includes a coil driver electrically coupled to the primary inductive coil and configured to adjust an output signal of the primary inductive coil. The wireless charging system further includes a receiver configured to receive an input signal from the portable electronic device, and a controller communicatively coupled to the receiver and to the coil driver. The controller is configured to establish a wireless charging protocol based on the input signal, and to automatically regulate the output signal based on the established wireless charging protocol and the input signal.

The present invention also relates to a wireless charging system including a primary inductive coil configured to transfer electromagnetic energy to a secondary inductive coil of a portable electronic device. The wireless charging system also includes a coil driver electrically coupled to the primary inductive coil and configured to adjust an output signal of the primary inductive coil. The wireless charging system further includes a feedback receiver electrically coupled to the primary inductive coil and configured to receive a feedback signal from the secondary inductive coil. In addition, the wireless charging system includes a controller communicatively coupled to the feedback receiver and to the coil driver. The controller is configured to receive a protocol identification signal, to identify a wireless charging protocol of the portable electronic device based on the protocol identification signal, and to automatically regulate the output signal based on the identified wireless charging protocol and the feedback signal.

The present invention further relates to a wireless charging system including a primary inductive coil configured to transfer electromagnetic energy to a secondary inductive coil of a portable electronic device. The wireless charging system also includes a coil driver electrically coupled to the primary inductive coil and configured to adjust an output signal of the primary inductive coil. The wireless charging system further includes a feedback receiver electrically coupled to the primary inductive coil and configured to receive a feedback signal from the secondary inductive coil. In addition, the wireless charging system includes a protocol identification receiver configured to receive a protocol identification signal from the portable electronic device, and a controller communicatively coupled to the feedback receiver, to the protocol identification receiver, and to the coil driver. The controller is configured to identify a wireless charging protocol of the portable electronic device by comparing the protocol identification signal to a stored list of candidate protocol identification signals, to receive a protocol specification signal configured to provide the controller with sufficient information to establish the wireless charging protocol if the protocol identification signal does not correspond to one of the candidate protocol identification signals, and to automatically regulate the output signal based on the wireless charging protocol and the feedback signal.

### DRAWINGS

FIG. 1 is a perspective view of an exemplary vehicle that may include a universal wireless charging system configured to automatically adapt to a variety of wireless charging protocols.

FIG. 2 is a perspective view of an exemplary floor console 16, as shown in FIG. 1, having a compartment configured to store and wirelessly charge portable electronic devices.

FIG. 3 is a schematic diagram of an exemplary wireless charging system configured to transfer electromagnetic energy to a portable electronic device.

FIG. 4 is a schematic diagram of an alternative embodiment of the wireless charging system, including a secondary controller.

FIG. 5 is a flow diagram of an exemplary method of automatically adapting to a variety of wireless charging protocols.

FIG. 6 is a flow diagram of an exemplary method of establishing a wireless charging protocol based on a feedback signal.

FIG. 7 is a flow diagram of an alternative method of establishing a wireless charging protocol based on the feedback signal.

FIG. 8 is a schematic diagram of an alternative embodiment of the wireless charging system, including a protocol identification receiver, and a protocol specification receiver.

FIG. 9 is a flow diagram of an alternative method for automatically adapting to a variety of wireless charging protocols.

FIG. 10 is a flow diagram of an exemplary method for receiving a protocol specification signal.

### DETAILED DESCRIPTION

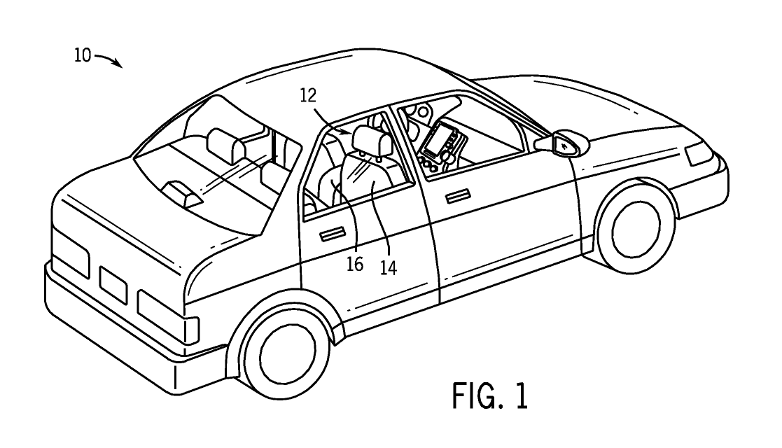

FIG. 1 is a perspective view of an exemplary vehicle 10 including a universal wireless charging system configured to automatically adapt to a variety of wireless charging protocols. As illustrated, the vehicle 10 includes an interior 12 having a seat 14 and floor console 16. In certain embodiments, the vehicle 10 includes a wireless charging system having a primary inductive coil in electromagnetic communication with an interior of a storage compartment within the floor console 16. In such embodiments, the primary inductive coil is configured to transfer electromagnetic energy to a secondary inductive coil of a portable electronic device disposed within the interior of the storage compartment. The wireless charging system also includes a coil driver electrically coupled to the primary inductive coil and configured to adjust an output signal of the primary inductive coil. In addition, the wireless charging system includes a receiver electrically coupled to the primary inductive coil and configured to receive a feedback signal from the secondary inductive coil. A controller communicatively coupled to the receiver and to the coil driver is configured to establish a wireless charging protocol based on the feedback signal, and to automatically regulate the output signal based on the established wireless charging protocol and the feedback signal. In this manner, a single wireless charging system may be employed to charge an assortment of portable electronic devices having a variety of wireless charging protocols.

While the wireless charging system is described below with reference to a compartment of a floor console 16, it should be appreciated that additional compartments located within other areas of the vehicle interior 12 may include a similar wireless charging systems. For example, in certain embodiments, a wireless charging system may be configured to provide electrical power to portable electronic devices located within a compartment or storage bin of a door panel, center stack, instrument panel, overhead console, vehicle seat or armrest, among other areas of the vehicle interior 12. In further embodiments, the wireless charging system may be configured to provide electrical power to portable electronic devices located adjacent to a surface within the vehicle interior 12. For example, in certain embodiments, the wireless charging system may be configured to charge portable electronic devices placed on a designed surface of the instrument panel, armrest or floor console 16. Furthermore, it should be appreciated that the wireless charging system described below may be configured to transfer electrical power to the portable electronic device by inductive charging or far field magnetic resonance, for example.

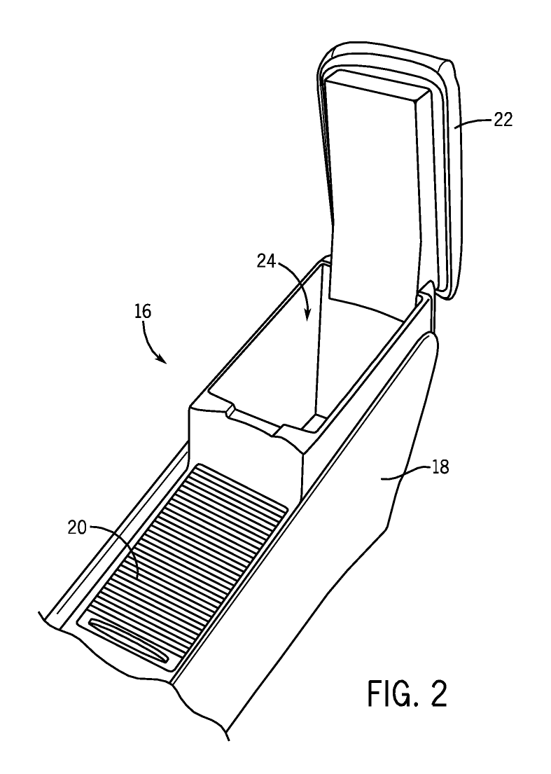

FIG. 2 is a perspective view of an exemplary floor console 16, as shown in FIG. 1, having a compartment configured to store and wirelessly charge portable electronic devices. As illustrated, the floor console 16 includes a body 18 enclosing one or more storage compartments. For example, the floor console 16 may include a storage compartment underneath the illustrated tambour door 20. As will be appreciated, the tambour door 20 may be configured to transition from the illustrated closed position to an open position that facilitates access to a storage compartment positioned at a front portion of the console 16. Similarly, the armrest 22 may rotate to enclose another storage compartment 24 positioned at a rear portion of the console 16. In certain configurations, the two storage compartments may be connected such that an occupant may access either storage compartment via the tambour door 20 or the armrest 22. It should be appreciated that alternative embodiments may include additional storage compartments positioned throughout the floor console 16.

In the present embodiment, a vehicle occupant may place a portable electronic device, such as a phone, camera or music player into the storage compartment 24 beneath the armrest 22. As discussed in detail below, a wireless charging system in electromagnetic communication with one of the interior surfaces of the compartment 24 may automatically identify the presence of the portable electronic device and begin transferring electrical power to the device via a wireless signal. For example, the wireless charging system may be located beneath a lower interior surface of the compartment 24. In this configuration, a portable electronic device placed adjacent to the lower surface will receive electromagnetic energy from the wireless charging system. In the present embodiment, the wireless charging system may be configured to establish a wireless charging protocol suitable for powering the particular portable electronic device disposed within the compartment 24. For example, the wireless charging system may identify the wireless charging protocol of the portable electronic device from a list of known protocols. Alternatively, the wireless charging system may vary an output signal, monitor resultant variations within a feedback signal, and establish a wireless charging protocol based on the resultant variations. In this manner, the wireless charging system may efficiently transfer power to an assortment of portable electronic devices having a variety of wireless charging protocols.

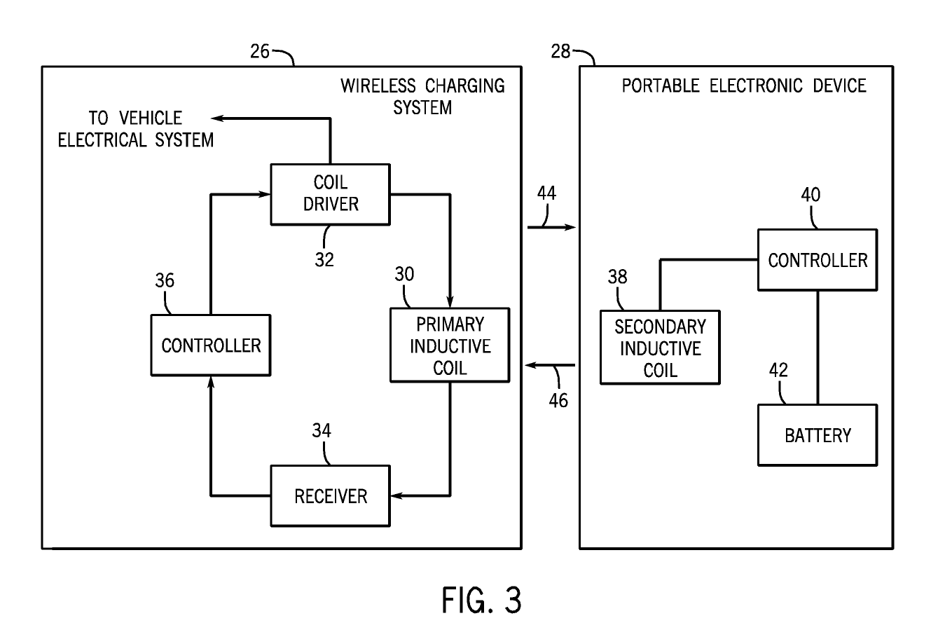

FIG. 3 is a schematic diagram of an exemplary wireless charging system 26 configured to transfer electromagnetic energy to a portable electronic device 28. As illustrated, the wireless charging system 26 includes a primary inductive coil 30, a coil driver 32, a receiver 34 and a controller 36. The primary inductive coil 30 is configured to transfer electromagnetic energy to a secondary inductive coil 38 of the portable electronic device 28. As previously discussed, the primary inductive coil 30 may be in electromagnetic communication with an interior of the compartment 24, thereby enabling the wireless charging system 26 to provide electrical power to a portable electronic device 28 disposed within the compartment 24. As discussed in detail below, the portable electronic device 28 includes a controller 40 electrically coupled to the secondary inductive coil 38, and a battery 42 electrically coupled to the controller 40. In this configuration, electromagnetic energy received by the secondary inductive coil 38 may be transferred to the battery 42, thereby charging the portable electronic device 28.

In the present embodiment, the coil driver 32 is electrically coupled to the primary inductive coil 30 and to the vehicle electrical system. The coil driver 32 is configured to receive power from the vehicle electrical system and to drive the primary inductive coil 30 with a desired signal. As will be appreciated, establishing an inductive resonance between the wireless charging system 26 and the portable electronic device 28 may enhance transfer efficiency of the electromagnetic energy. Consequently, the coil driver 32 may be configured to vary the resonance frequency of the wireless charging system 26 to match the frequency of the portable electronic device 28. For example, in certain embodiments, the coil driver 32 is configured to vary the frequency of the electrical power supplied to the primary inductive coil 30 by the vehicle electrical system. In addition, the coil driver 32 may be configured to vary the capacitance of an inductance/capacitance (LC) circuit established between the primary inductive coil 30 and the coil driver 32. As will be appreciated, the resonance frequency of an LC circuit may be adjusted by varying either the inductance or the capacitance. In certain embodiments, the inductance of the primary inductive coil 30 is fixed due to the number of windings within the coil 30. Consequently, the resonance of the LC circuit may be adjusted by varying the capacitance (e.g., via a variable capacitor) within the coil driver 32.

In addition, certain embodiments of the wireless charging system 26 include a primary inductive coil 30 having variable inductance. For example, certain primary inductive coils 30 may include multiple independent windings of conductive wire. In such configurations, each winding may include a different geometry (e.g., circular, polygonal, elliptical, etc.) and/or a different number of turns (i.e., number of loops of the conductive wire within the winding). Because the inductance of the primary inductive coil 30 is at least partially dependent on the geometry and number of turns of the winding, the controller 36 may adjust the inductance of the primary inductive coil 30 by switching between the independent windings. In further embodiments, the resonance frequency of the wireless charging system 26 may be varied by adjusting the capacitance of the coil driver 32 and the inductance of the primary inductive coil 30.

Furthermore, the coil driver 32 may adjust the amplitude of the electrical power supplied to the primary inductive coil 30, thereby varying the magnitude of an output signal 44. As will be appreciated, each portable electronic device 28 is configured to receive electromagnetic energy within a desired range of magnitudes. Consequently, the magnitude of the output signal 44 may be particularly adjusted to match the desired input range. In addition, as the charge within the battery 42 increases, the magnitude of the output signal 44 may be reduced, thereby substantially reducing or eliminating the possibility of overcharging the battery 42.

In the present embodiment, the receiver 34 is electrically coupled to the primary inductive coil 30 and configured to receive a feedback signal 46 from the secondary inductive coil 38. The feedback signal 46 may be indicative of a desired resonance frequency, a desired power input level or a desired electromagnetic frequency, among other parameters. For example, if an electromagnetic frequency of the output signal 44 is lower than desired, the controller 40 may instruct the secondary inductive coil 38 to generate a feedback signal 46 indicating that the output signal frequency should be increased. Similarly, if the magnitude of the output signal 44 is greater than desired, the controller 40 may instruct the secondary inductive coil 38 to generate a feedback signal 46 indicating that the output signal magnitude should be reduced. As will be appreciated, the format of the feedback signal 46 is based on the wireless charging protocol used by the portable electronic device 28.

The receiver 34 is communicatively coupled to the controller 36 and configured to relay the feedback signal 46 to the controller 36. The controller 36, in turn, is configured to regulate the output signal 44 based on the feedback signal 46. For example, if the primary coil 30 receives a feedback signal 46 indicating that the resonance frequency is lower than desired, the controller 36 may instruct the coil driver 32 to increase the resonance frequency. Similarly, if the primary coil 30 receives a feedback signal 46 indicating that the output signal magnitude is greater than desired, the controller 36 may instruct the coil driver 32 to reduce the magnitude of the output signal 44. Such adjustments to the output signal 44 may substantially increase the transfer efficiency of electrical power from the wireless charging system 26 to the portable electronic device 28. As will be appreciated, if the wireless charging system 26 and the portable electronic device 28 are operating on the same wireless charging protocol, the controller 36 will be able to properly interpret the feedback signal 46. Unfortunately, due to the variety of wireless charging protocols, a controller 36 with a single fixed wireless charging protocol may be unable to effectively communicate with different portable electronic devices 28.

In the present embodiment, the controller 36 is configured to automatically establish a wireless charging protocol capable of effectively communicating with the portable electronic device 28 by analyzing the feedback signal 46. For example, the wireless charging system 26 may compare the feedback signal 46 to a database of known feedback signals to identify the wireless charging protocol of the portable electronic device 28. Once the identified wireless charging protocol is established, the controller 36 may automatically regulate the output signal 44 based on the feedback signal 46 to establish an efficient transfer of electrical power to the portable electronic device 28. Alternatively, the controller 36 may vary the output signal 44, monitor resultant variations within the feedback signal 46, and establish a wireless charging protocol based on the resultant variations. In this manner, a wireless charging protocol may be established based on a previously unknown (at least to the controller 36) protocol.

In further embodiments, the controller 36 may be configured to establish the wireless charging protocol based on multiple training signals output from the portable electronic device 28. For example, the controller 40 may be configured to instruct the secondary inductive coil 38 to output a series of signals to the primary inductive coil 30. This series of signals may be configured to “teach” the controller 36 how to establish a wireless charging protocol that efficiently communicates with the portable electronic device 28. In one embodiment, the series of signals may include a first signal indicative of an excessively high output signal magnitude, a second signal indicative of an excessively low output signal magnitude, a third signal indicative of an excessively high resonance frequency, and a fourth signal indicative of an excessively low resonance frequency. If the controller 36 of the wireless charging system 26 is configured to correlate the order of the signals with the established meanings, the controller 36 may learn a previously unknown wireless charging protocol. In such a configuration, a single wireless charging system 26 may be employed to charge an assortment of portable electronic devices 28 having a variety of wireless charging protocols. As discussed in detail below, the portable electronic device may include additional transmitters configured to output the training signals, a protocol identification signal and/or a protocol specification signal to the wireless charging system. In such embodiments, the wireless charging system may include corresponding receivers to receive the signals, thereby enabling the controller to identify and/or establish the wireless charging protocol.

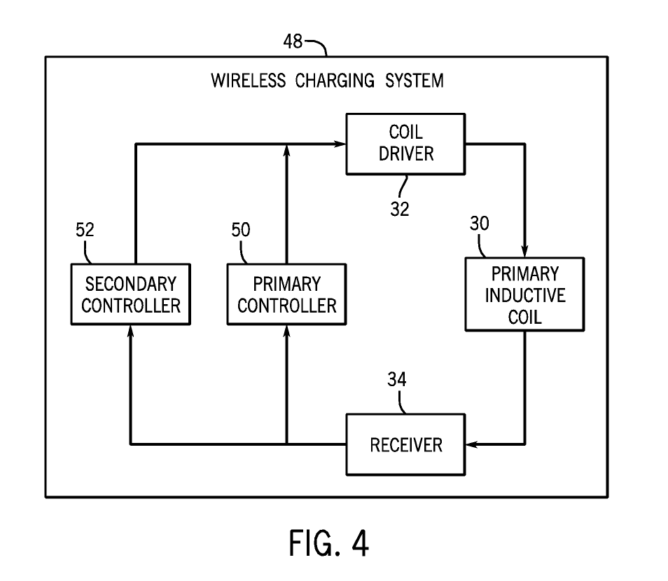

FIG. 4 is a schematic diagram of an alternative embodiment of the wireless charging system 48, including a secondary controller. As illustrated, the wireless charging system 48 includes a primary controller 50 and a secondary controller 52 communicatively coupled to the receiver 34 and to the coil driver 32. In the present embodiment, the primary controller 50 is configured to automatically establish a wireless charging protocol capable of communicating with the portable electronic device 28 by analyzing the feedback signal 46, similar to the embodiment described above with reference to FIG. 3. However, if the feedback signal 46 is indicative of a predetermined wireless charging protocol, control of the wireless charging system 48 will be transferred to the secondary controller 52. For example, the secondary controller 52 may be particularly configured to regulate the output signal 44 based on a single predetermined wireless charging protocol. Consequently, if the portable electronic device 28 is utilizing the predetermined wireless charging protocol, the secondary controller 52 may regulate the output signal 44 based on the input signal 46 and the predetermined wireless charging protocol. However, if the feedback signal 46 is not indicative of the predetermined protocol, the primary controller 50 may automatically establish an effective protocol based on an analysis of the feedback signal 46.

As will be appreciated, because the secondary controller 52 is particularly configured to regulate the output signal 44 based on a predetermined protocol, power transfer efficiency between the wireless charging system 48 and the portable electronic device 28 may be higher when the secondary controller 52 is operating the system 48. However, if an unknown (at least to the controllers 50 and 52) feedback signal 46 is detected, the primary controller 50 may still enable the wireless charging system 48 to transfer power to the portable electronic device 28, even if the transfer efficiency is slightly lower. In this manner, a single wireless charging system 48 may be employed to charge an assortment of portable electronic devices 28 having a variety of wireless charging protocols. While two controllers 50 and 52 are employed in the present embodiment, it should be appreciated that alternative embodiments may include a single controller capable of performing the functions of the primary controller 50 and the secondary controller 52. In further embodiments, multiple secondary controllers 52 may be employed to control the wireless charging system 48 based on multiple predetermined wireless charging protocols.

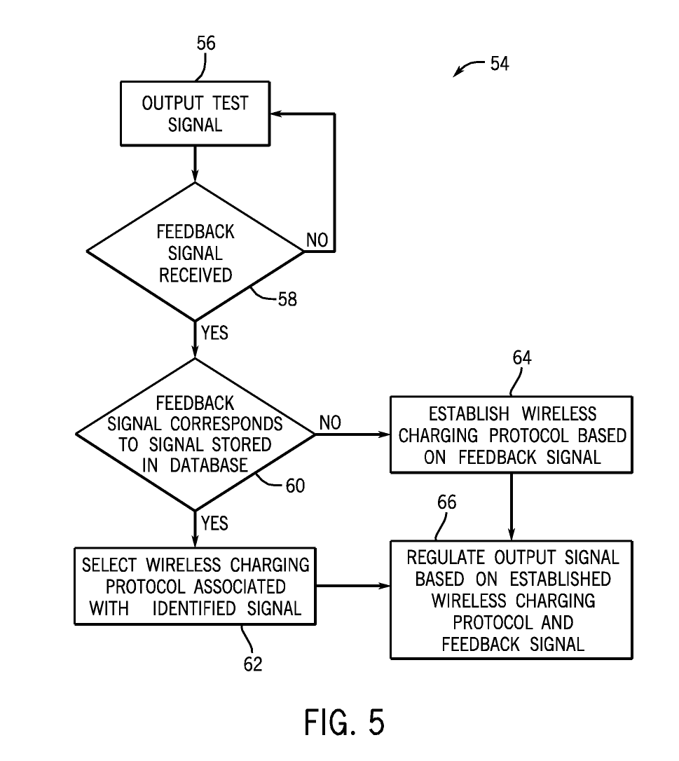

FIG. 5 is a flow diagram of an exemplary method 54 of automatically adapting to a variety of wireless charging protocols. First, as represented by block 56, a test signal may be output to determine whether a portable electronic device 28 is located within range of the wireless charging system 26. As previously discussed, the controller 40 of the portable electronic device 28 may be configured to instruct the secondary inductive coil 38 to generate a feedback signal 46 based on the output signal 44. Consequently, if a feedback signal 46 is received, as represented by block 58, a portable electronic device 28 is in range of the wireless charging system 26. Otherwise, additional test signals may be output until a portable electronic device 28 is detected.

Next, as represented by block 60, the feedback signal is compared to a database of known feedback signals, each associated with a previously established wireless charging protocol. If the feedback signal corresponds to a signal stored in the database, the wireless charging protocol associated with the identified signal may be selected, as represented by block 62. As the wireless charging system 26 is exposed to an increasing variety of wireless charging protocols, the database will expand to include the new protocols. As will be appreciated, selecting a wireless charging protocol from a database of previously established protocols may be substantially less computationally intensive than establishing a new wireless charging protocol. The process of establishing a wireless charging protocol based on the feedback signal 46, as represented by block 64, may be performed if the feedback signal does not correspond to a signal stored in the database. Once the wireless charging protocol is selected or established, the output signal may be regulated based on the wireless charging protocol and the feedback signal, as represented by block 66.

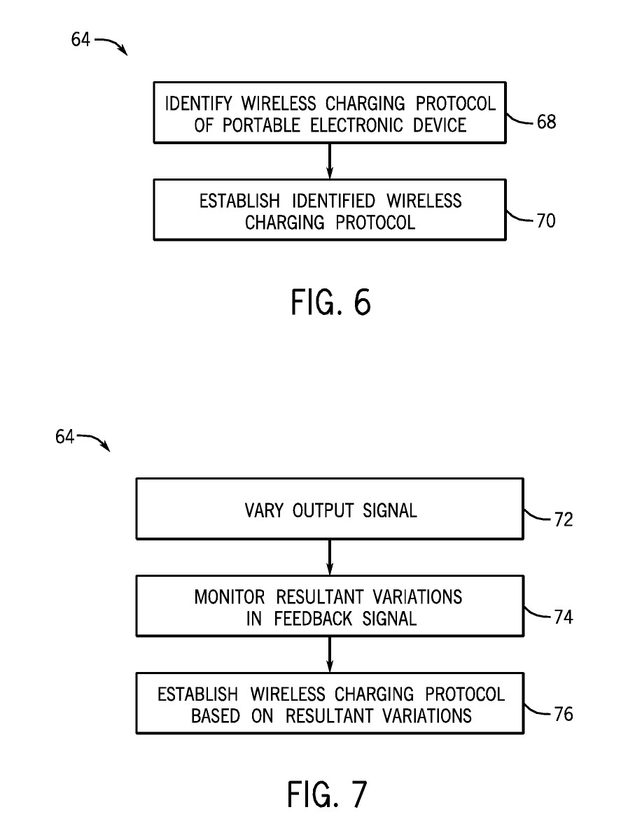

FIG. 6 is a flow diagram of an exemplary method 64 of establishing a wireless charging protocol based on a feedback signal 46. First, as represented by block 68, the wireless charging protocol of the portable electronic device 28 may be identified. For example, in certain embodiments, the controller 36 includes a list of known protocols. In such embodiments, the controller 36 will instruct the coil driver 32 to generate an output signal 44 in the format of the first protocol on the list. The controller 36 will then analyze the feedback signal 46 detected by the receiver 34 to determine whether the feedback signal 46 corresponds to an expected feedback signal based on the output signal 44 and the first protocol. If so, the controller 36 will select the first protocol to communicate with the portable electronic device 28. Otherwise, the controller 36 will instruct the coil driver 32 to generate an output signal 44 in the format of the second protocol on the list, and analyze the feedback signal 46 to determine whether the signal 46 corresponds to an expected feedback signal based on the output signal 44 and the second protocol. Such a process may be repeated until a wireless charging protocol is identified. The identified wireless charging protocol will then be established within the wireless charging system 26, as represented by block 70. In certain embodiments, the list may be expandable to incorporate additional wireless charging protocols.

FIG. 7 is a flow diagram of an alternative method 64 of establishing a wireless charging protocol based on the feedback signal 46. First, as represented by block 72, the output signal 44 generated by the primary inductive coil 30 is varied. For example, the controller 36 may instruct the coil driver 32 to adjust a frequency of the output signal 44, a magnitude of the output signal 44 and/or a resonance frequency of the wireless charging system 26. Next, the resultant variations in the feedback signal 46 are monitored, as represented by block 74. Finally, as represented by block 76, the wireless charging protocol will be established based on the resultant variations. By way of example, the controller 36 may increase the magnitude of the output signal 44, and monitor the resultant variations in the feedback signal 46. Next, the controller 36 may decrease the magnitude of the output signal 44, and monitor the resultant variations in the feedback signal 46. By associating the variations in the feedback signal 46 with the variations in the output signal 44, the controller 36 may “learn” how to control the output signal magnitude based on the feedback signal 46. The controller 36 may then repeat this process for the output frequency and resonance frequency to establish the wireless charging protocol for the particular portable electronic device 28.

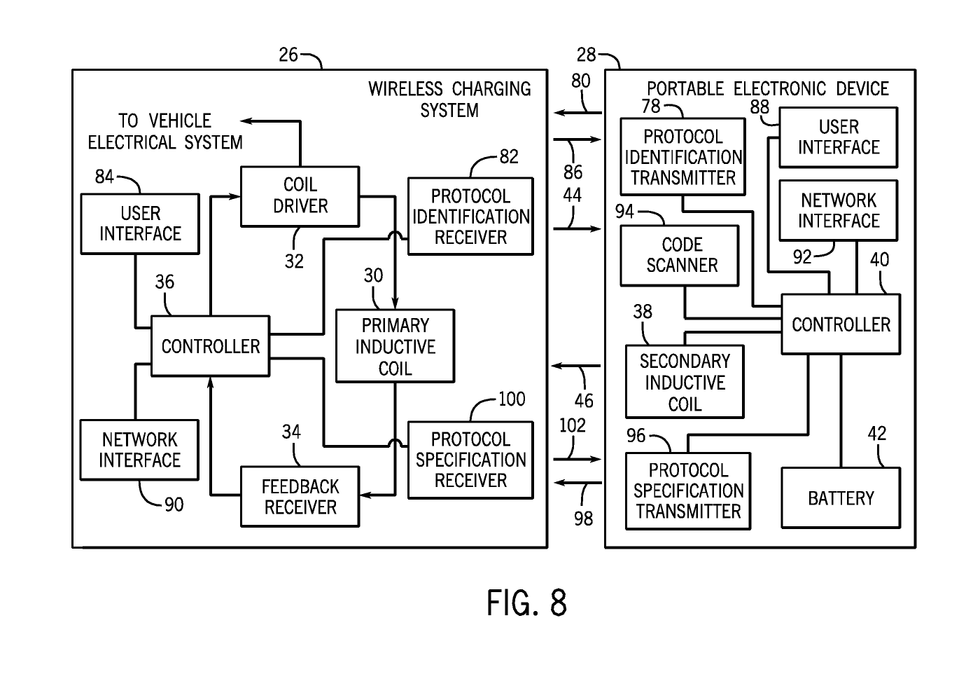

FIG. 8 is a schematic diagram of an alternative embodiment of the wireless charging system 26, including a protocol identification receiver, and a protocol specification receiver. As discussed in detail below, the illustrated wireless charging system 26 is configured to identify the wireless charging protocol of the portable electronic device 28 by comparing a protocol identification signal (e.g., output by the portable electronic device) to a stored list of candidate protocol identification signals. If a match is found, the wireless charging system will select the wireless charging protocol associated with the protocol identification signal. However, if the protocol identification signal does not match one of the candidate protocol identification signals, the wireless charging system 26 will receive a protocol specification signal configured to provide the wireless charging system with sufficient information to establish the wireless charging protocol. For example, the wireless charging system 26 may receive the protocol specification signal from the portable electronic device 28, or a remote network. The wireless charging system may then automatically regulate the output signal based on the identified wireless charging protocol and the feedback signal.

In the illustrated embodiment, the portable electronic device 28 includes a protocol identification transmitter 78 communicatively coupled to the controller 40, and configured to output a protocol identification signal 80. In addition, the wireless charging system 26 includes a protocol identification receiver 82 communicatively coupled to the controller 36, and configured to receive the protocol identification signal 80. The protocol identification signal 80 is configured to uniquely identify the wireless charging protocol of the portable electronic device 28. For example, the protocol identification signal 80 may include a numeric code that corresponds to a particular wireless charging protocol. Alternatively, the protocol identification signal 80 may include a numeric code that uniquely identifies the portable electronic device 28 (e.g., via a serial number). In such a configuration, the controller 36 may be configured to associate the particular portable electronic device with a particular wireless charging protocol (e.g., via a database of known identifiers).

In the present embodiment, the protocol identification signal 80 may be transmitted via a variety of wireless communication protocols. For example, the protocol identification transmitter 78 may be a Bluetooth transceiver configured to output a radio frequency signal to a corresponding Bluetooth transceiver (e.g., the protocol identification receiver 82) within the wireless charging system 26. Similarly, the protocol identification transmitter 78 and protocol identification receiver 82 may communicate via Wi-Fi, near field communication (NFC) and/or other standard or proprietary radio frequency protocols. In certain embodiments, the protocol identification transmitter 78 may be a radio frequency identification (RFID) tag (e.g., active or passive), and the protocol identification receiver 82 may be an RFID transceiver. In such a configuration, the protocol identification receiver 82 may be configured to transmit an interrogation signal to the protocol identification transmitter 78, and to receive a modulated response indicative of the protocol identification signal 80. In further embodiments, the protocol identification signal 80 may be transmitted via an optical (eg, infrared) connection between the transmitter 78 and the receiver 82.

In certain embodiments, the controller 36 may detect the presence of the portable electronic device 28 when the protocol identification receiver 82 receives the protocol identification signal 80. For example, if the transmitter 78 and the receiver 82 are configured to communicate via a radio frequency signal, the controller 36 may identify the presence of the portable electronic device 28 when the radio frequency signal is detected, or when the signal strength exceeds a threshold magnitude. Furthermore, if the protocol identification transmitter 78 is an RFID tag, the controller 36 may identify the presence of the portable electronic device 28 when the RFID tag is detected. Once the controller 36 determines that a portable electronic device 28 is present, the wireless charging system 26 may begin transferring electrical power to the portable electronic device 28.

In the illustrated embodiment, the controller 36 is configured to compare the protocol identification signal 80 to a stored list of candidate protocol identification signals (e.g. within a database in a memory of the controller 36). If the protocol identification signal corresponds to one of the candidate signals, the controller 36 will select the wireless charging protocol associated with the protocol identification signal 80. The controller 36 may then instruct a user interface 84, which is communicatively coupled to the controller 36, to indicate (e.g., via auditory and/or visual feedback) that a wireless charging protocol has been established. The controller 36 may then instruct the coil driver 32 to initiate wireless power transfer to the portable electronic device 28.

However, if the protocol identification signal does not match one of the candidate protocol identification signals, the controller 36 may instruct the user interface 84 to indicate that a wireless charging protocol has not been established. In addition, the controller 36 may instruct the protocol identification receiver 82 to output a return signal 86 to the protocol identification transmitter 78 indicating that the controller 36 does not recognize the protocol identification signal 80. If such a return signal is received, the controller 40 may instruct a user interface 88, which is communicatively coupled to the controller 40, to indicate that a wireless charging protocol has not been established. For example, the user interface 88 may include a graphical display, and the graphical display may be configured to present an icon and/or a textual message indicating that the wireless charging system 26 does not recognize the wireless charging protocol of the portable electronic device 28.

In certain embodiments, the user interface 84 of the wireless charging system 26 and/or the user interface 88 of the portable electronic device 28 may be employed to initiate transmission of the protocol identification signal 80 from the protocol identification transmitter 78 to the protocol identification receiver 82. For example, the user interface 88 may include a graphical display having a button configured to initiate transmission of the protocol identification signal. In such a configuration, a user may place the portable electronic device 28 proximate to the wireless charging system 26, and then depress the button. The wireless charging system 26 may then automatically receive the protocol identification signal 80 from the portable electronic device 28. Alternatively, the user interface 84 of the wireless charging system 26 may include a button configured to activate the protocol identification receiver 82, thereby facilitating receipt of the protocol identification signal 80. In such a configuration, the user may depress a first button on the wireless charging system user interface 84, and then depress a second button on the portable electronic device user interface 88 to initiate transmission of the protocol identification signal 80. In further embodiments, depressing a button on the user interface 84 may instruct the protocol identification receiver 82 to output a return signal 86 to the protocol identification transmitter 78 that instructs the controller 40 to initiate transmission of the protocol identification signal 80.

In certain embodiments, the wireless charging system 26 may omit the protocol identification receiver 82, and/or the portable electronic device 28 may omit the protocol identification transmitter 78. In addition, the protocol identification transmitter 78 may not be compatible with the protocol identification receiver 82 (e.g., the transmitter and the receiver may operate at different frequencies and/or employ different wireless communication protocols). In such embodiments, the user interface 84 may be configured to facilitate manual input of the protocol identification signal. For example, an identification number may be associated with the wireless charging protocol of the portable electronic device 28 (e.g., printed in an owner's manual, printed on the back of the device, etc.). In such an embodiment, a user may enter the identification number into the user interface 84, thereby providing the protocol identification signal to the controller 36.

As previously discussed, if the protocol identification signal 80 does not match one of the candidate protocol identification signals, the controller 36 may receive a protocol specification signal configured to provide the controller 36 with sufficient information to establish the wireless charging protocol. In the illustrated embodiment, the wireless charging system 26 includes a network interface 90 communicatively coupled to the controller 36, and configured to receive (e.g., download) a protocol specification signal from an external network. In certain embodiments, the network interface 90 is communicatively coupled to a wireless communication device (e.g., a cellular network adapter) configured to access the internet. In such embodiments, the controller 36 will instruct the network interface 90 to download a protocol specification signal from the internet that corresponds to the identified wireless charging protocol.

In further embodiments, the controller 36 may instruct the portable electronic device 28 to receive the protocol specification signal. For example, in certain embodiments, the portable electronic device 28 includes a network interface 92 communicatively coupled to the controller 40, and configured to receive (e.g., download) a protocol specification signal from an external network. In such embodiments, the controller 36 may instruct the protocol identification receiver 82 to output a return signal 86 to the protocol identification transmitter 78 that instructs the controller 40 to receive the protocol specification signal. As discussed in detail below, the portable electronic device 28 may then transmit the protocol specification signal to the wireless charging system 26 to facilitate establishment of the wireless charging protocol.

In the illustrated embodiment, the portable electronic device 28 includes a code scanner 94 communicatively coupled to the controller 40, and configured to electronically scan a code indicative of the protocol specification signal. For example, the code scanner 94 may be an RFID transceiver configured to receive the code from an RFID tag within the vehicle 10. Alternatively, the code scanner 94 may be an optical scanner configured to read a bar code or a quick response (QR) code (e.g., within the vehicle 10, within an owner's manual, etc.). Once the code has been scanned, the controller 40 may instruct the network interface 92 to receive a protocol specification signal corresponding to the code. The portable electronic device 28 may then transmit the protocol specification signal to the wireless charging system 26 to facilitate establishment of the wireless charging protocol.

In the illustrated embodiment, the portable electronic device 28 employs a protocol specification transmitter 96, which is communicatively coupled to the controller 40, to transmit a protocol specification signal 98 to the wireless charging system 26. The wireless charging system 26, in turn, includes a protocol specification receiver 100, communicatively coupled to the controller 36, and configured to receive the protocol specification signal 98. As previously discussed, the protocol specification signal may be received from the network interface 92 of the portable electronic device 28. Alternatively, the protocol specification signal may be stored within a memory of the controller 40 of the portable electronic device 28. Once the controller 36 receives the protocol specification signal 98, the controller 36 may establish the wireless charging protocol of the portable electronic device 28.

Similar to the protocol identification signal 80, the protocol specification signal 98 may be transmitted via a variety of wireless communication protocols. For example, the protocol specification transmitter 96 may be a Bluetooth transceiver configured to output a radio frequency signal to a corresponding Bluetooth transceiver (e.g., the protocol specification receiver 100) within the wireless charging system 26. Similarly, the protocol specification transmitter 96 and the protocol specification receiver 100 may communicate via Wi-Fi, near field communication (NFC) and/or other standard or proprietary radio frequency protocols. In certain embodiments, the protocol specification transmitter 96 may be a radio frequency identification (RFID) tag (e.g., active or passive), and the protocol specification receiver 100 may be an RFID transceiver. In such a configuration, the protocol specification receiver 100 may be configured to transmit an interrogation signal to the protocol specification transmitter 96, and to receive a modulated response indicative of the protocol specification signal 98. In further embodiments, the protocol specification signal 98 may be transmitted via an optical (e.g., infrared) connection between the transmitter 96 and the receiver 100.

In certain embodiments, the controller 36 is configured to instruct the protocol specification receiver 100 to output a return signal 102 to the protocol specification transmitter 96 indicating whether the protocol specification signal 98 was successfully received and/or whether the wireless charging system 26 is capable of establishing the identified wireless charging protocol. For example, if the protocol specification receiver 100 does not receive a complete protocol specification signal 98, the controller 36 may instruct the protocol specification receiver 100 to output a return signal 102 indicating that a complete signal was not received. Accordingly, the controller 40 may instruct the protocol specification transmitter 96 to resend the protocol specification signal 98. In addition, the controller 40 may instruct the user interface 88 to inform a user that the signal was not received (e.g., via presenting an error message on a display, activating an audible alarm, etc.). Similarly, the controller 36 may instruct the user interface 84 of the wireless charging system 26 to inform a user that the signal was not received.

Furthermore, if the controller 36 determines that the wireless charging system 26 is not capable of establishing the wireless charging protocol of the portable electronic device, the protocol specification receiver 100 may output a return signal 102 to the protocol specification transmitter 96 indicating that the identified wireless charging protocol may not be established. In addition, the user interface 88 of the portable electronic device 28 and/or the user interface 84 of the wireless charging system 26 may provide auditory and/or visual feedback to the user indicating that the identified wireless charging protocol may not be established. However, in certain embodiments, the controller 36 may be configured to establish a wireless charging protocol sufficiently similar to the identified wireless charging protocol, thereby enabling energy transfer to the portable electronic device 28 (e.g., with decreased efficiency/performance). For example, if the resonance frequency of the identified wireless charging protocol is greater than the maximum resonance frequency of the wireless charging system 26, the wireless charging system 26 may transmit electrical power at the maximum resonance frequency, thereby supplying electrical power to the portable electronic device (e.g., with reduced efficiency/performance). In such embodiments, the portable electronic device user interface 88 and/or the wireless charging system user interface 84 may alert the user to the variation in wireless charging protocols, and enable the user to authorize energy transfer to the portable electronic device 26 via a sufficiently similar wireless charging protocol.

As previously discussed, the protocol specification signal 98 includes sufficient information for the controller 36 to establish the identified wireless charging protocol. For example, in certain embodiments, the protocol specification signal 98 may include physical parameters of the identified wireless charging protocol, such as resonance frequency, inductance, capacitance, and output signal magnitude. The protocol specification signal 98 may also include training signals configured to “teach” the controller 36 how to establish a wireless charging protocol that efficiently communicates with the portable electronic device 28. In certain embodiments, the training signals may include software (e.g., executable code) that instructs the controller 36 how to respond to feedback signals 46 from the portable electronic device 28. Consequently, when the controller 36 establishes the wireless charging protocol based on the protocol specification signal, the wireless charging system 26 may efficiently transfer electrical power to the portable electronic device 28.

In addition, the controller 36 may be configured to store the protocol specification signal, thereby enabling the controller 36 to effectively establish the wireless charging protocol when the associated protocol identification signal is subsequently received. Furthermore, while the wireless charging system 26 employs separate receivers 34, 82 and 100, and the portable electronic device employs separate transmitters 78 and 96 in the illustrated embodiment, it should be appreciated that alternative embodiments may utilize an integrated receiver and/or transmitter. In such embodiments, the integrated transmitter may be configured to transmit the protocol identification signal 80 and the protocol specification signal 98, and the integrated receiver may be configured to receive the feedback signal 46, the protocol identification signal 80 and the protocol specification signal 98.

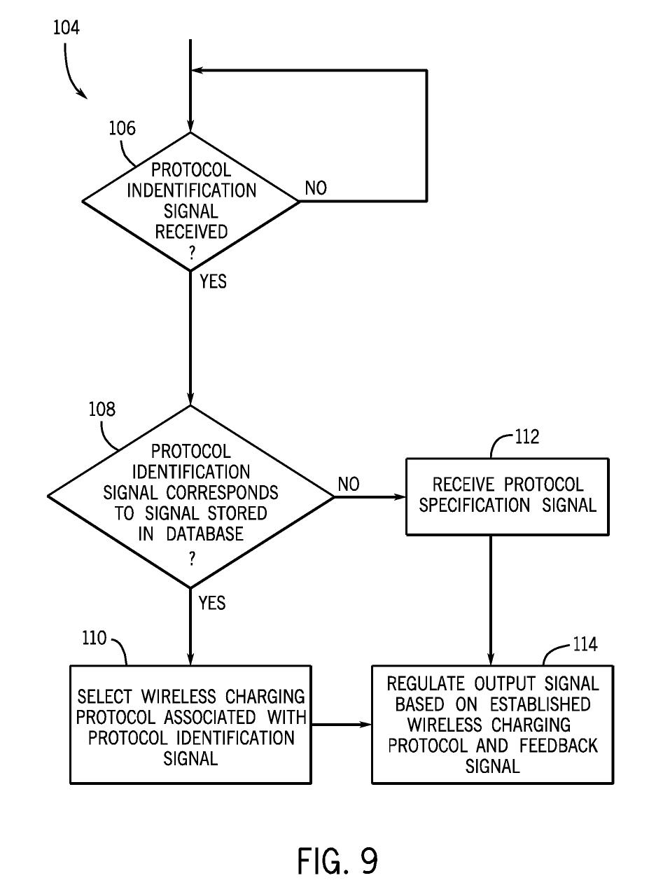

FIG. 9 is a flow diagram of an alternative method 104 for automatically adapting to a variety of wireless charging protocols. First, as represented by block 106, a determination is made regarding whether a protocol identification signal has been received. For example, in certain embodiments, the controller 36 may instruct the protocol identification receiver 82 to transmit interrogation signals until a protocol identification transmitter 78 returns a protocol identification signal 80, thereby indicating the presence of a portable electronic device 28. Next, as represented by block 108, the protocol identification signal is compared to a database of known protocol identification signals. If the protocol identification signal corresponds to a signal stored in the database, the wireless charging protocol associated with the protocol identification signal is selected, as represented by block 110. As will be appreciated, selecting a wireless charging protocol from a database of previously established protocols may be substantially less computationally intensive than establishing a new wireless charging protocol or receiving a new wireless charging protocol from an external source. The process of receiving a protocol specification signal configured to provide the wireless charging system with sufficient information to establish the wireless charging protocol, as represented by block 112, may be performed if the protocol identification signal does not correspond to a signal stored in the database. Once the wireless charging protocol is selected or established, the output signal may be regulated based on the wireless charging protocol and the feedback signal, as represented by block 114.

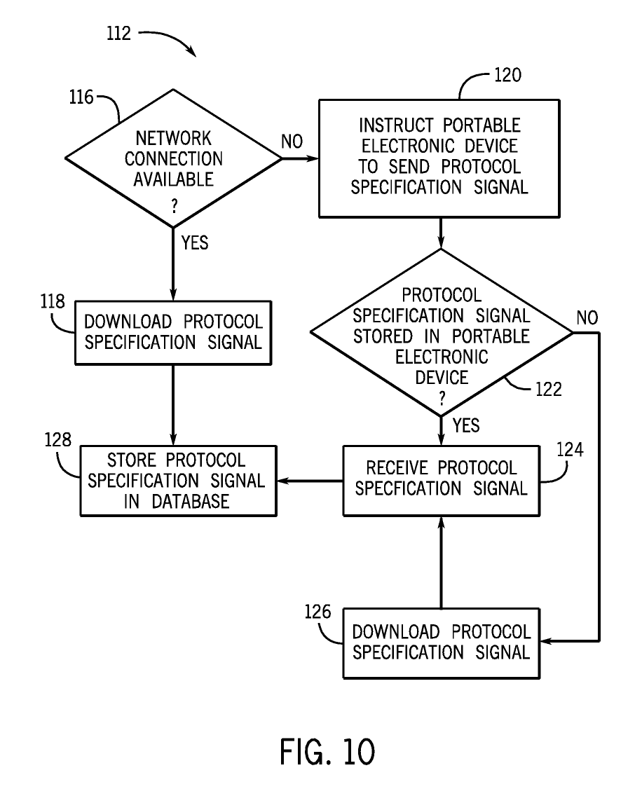

FIG. 10 is a flow diagram of an exemplary method 112 for receiving a protocol specification signal. First, as represented by block 116, a determination is made regarding whether a network connection is available. For example, in certain embodiments, the wireless charging system 26 may include a network interface 90 configured to access the internet via a wireless communication device (e.g., a cellular network adapter). If a wireless connection is available, a protocol specification signal is downloaded, as represented by block 118. Otherwise, the portable electronic device is instructed to send the protocol specification signal to the wireless charging system, as represented by block 120. If the protocol specification signal is stored within the portable electronic device, as represented by block 122, the protocol specification signal is transmitted, thereby enabling the wireless charging system to receive the protocol specification signal, as represented by block 124. Otherwise, the protocol specification signal is downloaded (e.g., from an external network), as represented by block 126, and then transmitted to the wireless charging system. Once the protocol specification signal is received, the protocol specification signal is stored in a database, as represented by block 128. Consequently, if the wireless charging system detects a subsequent portable electronic device having the same protocol identification signal, the wireless charging system may establish a wireless charging protocol based on the protocol specification signal stored in the database.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A wireless charging system, comprising:
a primary inductive coil configured to transfer electromagnetic energy to a secondary inductive coil of a portable electronic device;
a coil driver electrically coupled to the primary inductive coil and configured to adjust an output signal of the primary inductive coil;
a receiver configured to receive an input signal from the portable electronic device; and
a controller communicatively coupled to the receiver and to the coil driver, wherein the controller is configured to establish a wireless charging protocol based on the input signal, and to automatically regulate the output signal based on the established wireless charging protocol and the input signal.

2. The wireless charging system of claim 1, wherein the input signal comprises a feedback signal from the secondary inductive coil, and the receiver is configured to receive the feedback signal through the primary inductive coil.

3. The wireless charging system of claim 2, wherein the controller is configured to establish the wireless charging protocol by identifying a secondary wireless charging protocol of the portable electronic device based on the feedback signal, and establishing the identified secondary wireless charging protocol.

4. The wireless charging system of claim 2, wherein the controller is configured to establish the wireless charging protocol by varying the output signal, and monitoring resultant variations within the feedback signal.

5. The wireless charging system of claim 2, comprising a secondary controller communicatively coupled to the receiver and to the coil driver, wherein the secondary controller is configured to automatically regulate the output signal based on the feedback signal if the feedback signal is indicative of a predetermined wireless charging protocol.

6. The wireless charging system of claim 1, wherein the controller is configured to instruct the coil driver to output a test signal, and to identify a presence of the portable electronic device based on a return signal received by the receiver.

7. The wireless charging system of claim 1, wherein the input signal comprises a protocol identification signal, and the controller is configured to establish the wireless charging protocol by identifying a secondary wireless charging protocol of the portable electronic device based on the protocol identification signal, and establishing the identified secondary wireless charging protocol.

8. The wireless charging system of claim 7, wherein the controller is configured to receive a protocol specification signal configured to provide the controller with sufficient information to establish the identified secondary wireless charging protocol.

9. The wireless charging system of claim 8, wherein the input signal comprises the protocol specification signal.

10. The wireless charging system of claim 1, wherein the controller is configured to associate the established wireless charging protocol with the portable electronic device, to automatically select the established wireless charging protocol upon detection of the portable electronic device, and to automatically regulate the output signal based on the selected wireless charging protocol and the input signal.

11. A wireless charging system, comprising:
a primary inductive coil configured to transfer electromagnetic energy to a secondary inductive coil of a portable electronic device;
a coil driver electrically coupled to the primary inductive coil and configured to adjust an output signal of the primary inductive coil;
a feedback receiver electrically coupled to the primary inductive coil and configured to receive a feedback signal from the secondary inductive coil; and
a controller communicatively coupled to the feedback receiver and to the coil driver, wherein the controller is configured to receive a protocol identification signal, to identify a wireless charging protocol of the portable electronic device based on the protocol identification signal, and to automatically regulate the output signal based on the identified wireless charging protocol and the feedback signal.

12. The wireless charging system of claim 11, comprising a protocol identification receiver configured to automatically receive the protocol identification signal from the portable electronic device.

13. The wireless charging system of claim 11, wherein the controller is configured to identify the wireless charging protocol of the portable electronic device by comparing the protocol identification signal to a stored list of candidate protocol identification signals.

14. The wireless charging system of claim 13, wherein the controller is configured to receive a protocol specification signal configured to provide the controller with sufficient information to establish the identified wireless charging protocol if the protocol identification signal does not correspond to one of the candidate protocol identification signals.

15. The wireless charging system of claim 14, wherein the protocol specification signal is received from the portable electronic device.

16. A wireless charging system, comprising:
a primary inductive coil configured to transfer electromagnetic energy to a secondary inductive coil of a portable electronic device;
a coil driver electrically coupled to the primary inductive coil and configured to adjust an output signal of the primary inductive coil;
a feedback receiver electrically coupled to the primary inductive coil and configured to receive a feedback signal from the secondary inductive coil;
a protocol identification receiver configured to receive a protocol identification signal from the portable electronic device; and
a controller communicatively coupled to the feedback receiver, to the protocol identification receiver, and to the coil driver, wherein the controller is configured to identify a wireless charging protocol of the portable electronic device by comparing the protocol identification signal to a stored list of candidate protocol identification signals, to receive a protocol specification signal configured to provide the controller with sufficient information to establish the wireless charging protocol if the protocol identification signal does not correspond to one of the candidate protocol identification signals, and to automatically regulate the output signal based on the wireless charging protocol and the feedback signal.

17. The wireless charging system of claim 16, wherein the controller is configured to store the protocol identification signal and a corresponding protocol specification signal in the stored list of candidate protocol identification signals.

18. The wireless charging system of claim 16, comprising a protocol specification receiver communicatively coupled to the controller, wherein the protocol specification receiver is configured to receive the protocol specification signal from the portable electronic device.

19. The wireless charging system of claim 16, comprising a network interface communicatively coupled to the controller, wherein the network interface is configured to receive the protocol specification signal from an external network.

20. The wireless charging system of claim 16, comprising a user interface communicatively coupled to the controller, wherein the user interface is configured to facilitate manual input of the protocol identification signal, to initiate receipt of the protocol identification signal, to initiate receipt of the protocol specification signal, to provide auditory or visual feedback to a user, or a combination thereof
